(19) United States
(12) Patent Application Publication
(10) Pub. No.: US 2004/0237120 A1
(43) Pub. Date: Nov. 25, 2004

(54) Systems and methods for dynamically generating and distributing synchronized enhancements to a broadcast signal

(76) Inventors: Blake P. Lewin, Lilburn, GA (US); Stephen Graham Woodward, Atlanta, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/443,643

(22) Filed: May 22, 2003

(51) Int. Cl. H04N 7/16

(52) U.S. Cl. 725/135; 725/136; 715/500.1; 715/501.1

(57) ABSTRACT

Systems and methods are disclosed to dynamically generate and distribute a synchronized media presentation. The present invention provides for the automated retrieval, assembly and formatting of an enhanced media presentation and the synchronous delivery of that presentation. The enhancing content is synchronized so that its delivery coincides with a broadcast signal or other media program that it is designed to enhance without requiring that the enhancing content be physically bound to the media program. Another aspect of the invention is that the assembly and synchronization of the enhancing content is independent of the distribution channel and platform used to execute or display the enhanced content. As a result, the enhancing content can be formatted for a set-top box, a personal computer, a personal video recorder, an audio system or any other platform used to deliver a media program to a user.

### FIELD OF THE INVENTION

The present invention relates generally to interactive information systems and, more particularly, to systems and methods that dynamically generate and distribute a synchronized media presentation.

### BACKGROUND OF THE INVENTION

Interactive television (ITV) is one form of an emerging technology that is known as interactive information systems. In the case of ITV, an interactive system is used to enhance the viewing experience of the television viewer. Typically, the enhancement comes from media in the form of text or graphic images that accompany the traditional video associated with a television program. The technology allows a television network or other provider of television content to use the television set as a vehicle for new, services and marketing opportunities.

A set-top box connected to the television controls the interactive functionality of the television. The set-top box receives the signal transmitted by the broadcast service provider, separates the enhanced television content from the broadcast feed and decompresses the respective portions of the signal. The set-top box uses the enhanced content to, for example, execute an application while the broadcast information is transmitted to the television. The set-top box may combine the broadcast feed with interactive graphics or audio generated from the enhanced content prior to transmitting the information to the television. The interactive graphics and audio may present additional information to the viewer or may prompt the viewer for input. And the set-top box may provide viewer input or other information to the broadcast service provider via a modem connection.

One problem with interactive information systems such as ITV as they exist today is the difficulty of synchronizing the media that is used to enhance a broadcast signal (the media used to enhance the signal is referenced herein as the “media presentation”) with the broadcast signal. The process is often manual and requires that an engineer from a broadcast operations center (BOC) call the distributor of the media presentation and orally countdown to the launch of the broadcast. Upon receiving a “go” signal from the engineer, the distributor begins transmitting the media presentation and hopes that the presentation runs synchronously with the broadcast signal. But if there is a miscommunication between the engineer and media distributor or if there is an unanticipated interruption in the broadcast signal, the media presentation loses sync with the broadcast signal.

Another known approach to synchronizing a media presentation with a broadcast signal is to add triggers to the tape of the broadcast. As the broadcast tape is shown, the triggers in the tape are read by a device, usually a computer, and are fed to an application that tracks the media presentation to keep it in sync with the broadcast signal. In still another approach, an ITV-enabled set-top box physically embeds the media presentation in the broadcast feed where it is read.

The problem with either of these approaches is that the media presentation is physically tied to the broadcast signal. Thus, once the media presentation and/or broadcast triggers are embedded in the signal, it is very difficult for anyone to add to or change the media used to enhance the broadcast signal. Another problem is that there are often multiple versions or edits of a given television program and the broadcast triggers and media presentation must be individually embedded in the videotape used to store each edit.

Another known issue with interactive information systems is the problem of starting and stopping the media presentation to account for commercials or other breaks in the television programming. Providers of enhanced video systems generally do not run the media presentation during commercial breaks, in part because the advertisers that pay for the commercials do not want viewers distracted by the media enhancements while the commercial is broadcast. One method that has been used to address this problem is to create an application that is programmed to start and stop the media presentation at preset times. But practice has shown that this has limited effectiveness and rarely works for a television program that lasts longer than an hour. This approach is also prone to error if an unanticipated interruption in the broadcast signal causes the media presentation to lose sync with the broadcast signal.

A recognized need therefore exists in the industry for systems and methods that generate and deliver a media presentation in sync with a broadcast signal or other media format that the presentation is designed to enhance.

### SUMMARY OF THE INVENTION

Systems and methods are disclosed to dynamically generate and distribute a synchronized media presentation. The present invention provides for the automated retrieval, assembly and formatting of an enhanced media presentation and the synchronous delivery of that presentation. The enhancing content is synchronized so that its delivery coincides with a broadcast signal or other media program that it is designed to enhance without requiring that the enhancing content be physically bound to the media program. Another aspect of the invention is that the assembly and synchronization of the enhancing content is independent of the distribution channel and platform used to execute or display the enhanced content. As a result, the enhancing content can be formatted for a set-top box, a personal computer, a personal video recorder, an audio system or any other platform used to deliver a media program to a user.

In one embodiment of the invention an interactive information system is disclosed that assembles and delivers a media presentation used to enhance a video event such that the media presentation is delivered to a distribution channel at a time that coincides with a broadcast of the video event. In this embodiment, the system includes a broadcast timing server that monitors a playlist of events that are scheduled for broadcast and is configured to generate an on-horizon and an on-air trigger, wherein the on-horizon trigger indicates that a new video event has entered the playlist and the on-air trigger indicates that the new video event has started to broadcast; and a media presentation engine that assembles the media presentation in response to the on-horizon trigger and delivers the media presentation to the distribution channel in response to the on-air trigger.

In another embodiment, the on-horizon trigger includes an event identifier that identifies the new video event and the media presentation engine is configured to query a media content database with the event identifier to retrieve a script that is associated with the new event.

In still another embodiment, the media presentation engine is further configured to associate a timer with the media elements and to start the timer in response to the on-air trigger such that the media elements are delivered at a time determined by the timer. In one example, the media presentation engine retrieves a media element from a dynamic data source at a time determined by the timer.

In another embodiment of the invention a method of assembling and delivering a plurality of media presentations to a plurality of distribution channels is disclosed such that the deliveries coincide with a broadcast of an event. The method includes the steps of receiving a first notice that indicates that the event has entered a playlist of events that are scheduled for broadcast; assembling a first and second media presentation in response to the notice; and delivering the first media presentation to the first distribution channel and the second media presentation to the second distribution channel upon receipt of a second notice that indicates that the broadcast of the event has started.

In still another embodiment, the first distribution channel is associated with a first platform and the second distribution channel is associated with a second platform that is different from the first. In addition, the method can also include the steps of combining the first media presentation with the broadcast to create a first enhanced broadcast signal and using the second media presentation to create a second enhanced broadcast signal.

In another embodiment of the present invention, a method of assembling and delivering a media presentation to a distribution channel is disclosed such that the delivery of the media presentation coincides with the broadcast of an event. The method disclosed includes the steps of receiving an on-horizon trigger that indicates the event is scheduled for broadcast, the on-horizon trigger including an event identifier associated with the event; querying a database of media elements with the event identifier to capture a script that identifies one or more media elements that are to be broadcast with the event; assembling a media presentation based at least in part on the one or more identified media elements; and delivering the assembled media presentation to the distribution channel upon receipt of a notice indicating that a broadcast has started.

In another embodiment, the step of assembling the media presentation is further separated into the steps of retrieving the media elements from a media content database; formatting the media elements for the distribution channel; and storing the media elements in a cache. And, in an embodiment, the step of delivering the assembled media presentation includes the steps of receiving a notice that indicates that a broadcast of the event has started; parsing the notice to capture an on-air event identifier for the event; querying the cache with the on-air event identifier to identify the media presentation associated with the event; and transferring the media presentation from the cache to the distribution channel.

In still another embodiment, the step of delivering the assembled media presentation includes the steps of receiving a notice that indicates that a broadcast has started; parsing the notice to capture an on-air event identifier; querying the cache with the on-air event identifier to identify the media presentation; capturing one or more dynamic media elements from a dynamic data source; merging the dynamic media elements with the cached media elements; and transferring the merged media presentation from the cache to the distribution channel.

In another embodiment of the present invention, a method of using media to enhance a video event and of delivering the enhancements to a distribution channel to coincide with a broadcast of the video event is disclosed that includes the steps of receiving a notice that indicates that the video event has entered a playlist of events that are scheduled for broadcast; retrieving a plurality of scripts that are associated with the video event; selecting one of the plurality of scripts to use with the broadcast of the video event; assembling a media presentation associated with the selected script; and delivering the media presentation to the distribution channel to coincide with the broadcast of the video event. In one embodiment, each of the plurality of scripts identifies a different media presentation.

In another embodiment of the present invention a method of synchronizing a media presentation for an event that is scheduled to air on a television network and of delivering the media presentation to the network via a distribution channel that is associated with the television network is disclosed that includes the steps of capturing an event identifier for the event; querying a database of media elements to identify one or more media elements that are associated with the event identifier; assembling the media presentation based at least in part on the identified media elements; caching the media presentation; and delivering the media presentation to the distribution channel in response to a notice that the event has started to broadcast.

In another embodiment of the present invention a method of enhancing a video event by delivering a media presentation to a distribution channel to coincide with the start of a broadcast of the video event is disclosed that includes the steps of receiving a notice that indicates that the video event has entered a playlist of video events that are scheduled for broadcast; retrieving a script that describes a media presentation associated with the video event, wherein the media presentation has a static portion and a dynamic portion; assembling the static portion of the media presentation; storing the static portion in a memory area; retrieving the dynamic portion of the media presentation in response to a notice that the broadcast of the video event has started; and delivering the static and dynamic portions of the media presentation to the distribution channel.

In another embodiment, the step of retrieving a dynamic portion includes retrieving an XML feed from a dynamic data source and the process further includes the steps of parsing the XML feed to capture one or more media elements that are referenced in the script; and generating an internal XML file that includes the media elements referenced in the script and a media display instruction that describes how the media elements are to be displayed.

In another embodiment of the present invention, an interactive information system that assembles and delivers a media presentation used to enhance a video event is described such that the media presentation is delivered to a distribution channel at a time that coincides with a broadcast of the video event. This embodiment includes a broadcast timing server that monitors a playlist of events that are scheduled for broadcast and generates a trigger when a new video event enters the playlist, wherein the trigger includes an event identifier associated with the new video event; and a media presentation engine that receives the trigger and queries a media database with the event identifier to identify a plurality of media presentations that are associated with the new video event, the media presentation engine further configured to select one of the plurality of media presentations and to assemble and deliver the selected media presentation to the distribution channel when the new video event begins to air.

In yet another embodiment of the present invention, a method is described that includes the steps of detecting entry of a media event into a playlist; assembling a media presentation based on the media event, the media presentation for enhancing the media event; and delivering the media presentation for broadcast along with the event based on the event reaching the top of the playlist and beginning to play.

In still another embodiment, a method is disclosed that includes the steps of retrieving a script based on a media event to be broadcast; executing the script to generate a media presentation to be broadcast with said media event; and delivering the media presentation for broadcast along with the media event.

Another embodiment of the present is an ITV system that reads a video playlist data directly from a broadcast operations Center and has the ability to know what is being broadcast at any given moment in time. With this information, the system dynamically assembles synchronous and asynchronous programming information, sports data feeds and produced content to be distributed with the programming. Using platform appropriate technical and business rules, the system distributes content directly to each interactive platform (set-top boxes, wireless devices, PC, etc.), and by combining schedule and tune-in information with entertaining show specific content (trivia, facts, scores, standings, etc.), the system creates an in-program, promotional marketing and ad sales tool for networks.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of an interactive content generation and distribution system in accordance with an embodiment of the present invention.

FIG. 2 is a flow chart that shows the processing that occurs when a new event appears on the broadcast playlist.

FIG. 3 is a flow chart that shows the processing that occurs when an event goes on-air.

FIG. 4 is a flow chart that shows the steps taken to retrieve, assemble and format interactive content for an event.

### DETAILED DESCRIPTION OF THE INVENTION

The systems and methods disclosed herein, in their various embodiments, overcome the above-stated disadvantages of previous technologies, and achieve numerous advantages that were not possible before such systems and methods.

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

The present invention is described below with reference to block diagrams and flowchart illustrations of methods, apparatus (i.e., systems) and computer program products according to an embodiment of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions, which execute on the computer or other programmable data processing apparatus create means for implementing the functions specified in the system or flowchart blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems which perform the specified functions or steps, or combinations of special purpose hardware and computer instructions.

Although the present invention is described generally in the context of an ITV system, one of ordinary skill in the art will readily recognize that the present invention will be equally advantageous with any system that provides enhanced content to media, whether that media is a video signal, personal video recorder, electronic mail or other media that is known in the art.

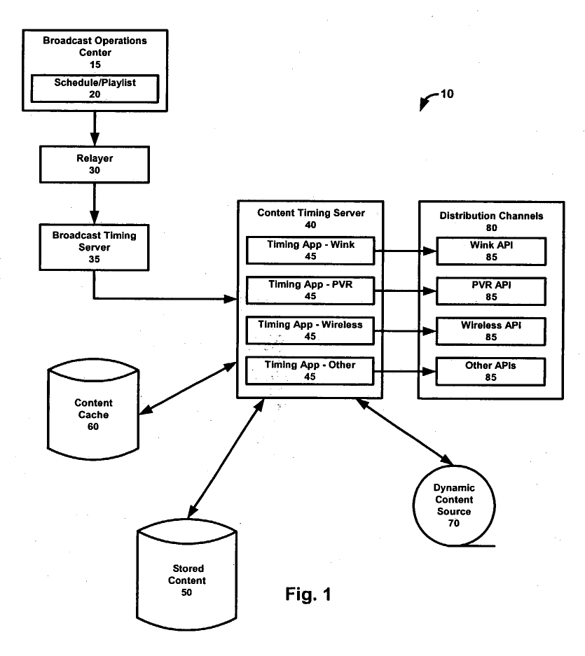

FIG. 1 illustrates an enhanced media generation and distribution system 10 in accordance with an embodiment of the present invention. A function of the system 10 is to assemble media elements into a media presentation and synchronize the delivery of the assembled media presentation with a broadcast signal to provide an enhanced programming experience for the viewer. As used herein, the term media element will refer to any type of media content or data element that can accompany a broadcast signal to enhance the programming experience. The term media presentation is used herein to refer to a grouping of one or more media elements that are assembled and formatted for synchronization with a broadcast signal. Finally, the term enhanced broadcast signal refers to a broadcast signal that has been enhanced with a synchronized media presentation.

In the embodiment of FIG. 1, the system 10 includes a schedule or playlist 20 that resides on a server of a BOC 15, a relayer 30, a broadcast timing server 35, one or more timing applications 45 that may (or may not) reside on a content timing server 40, a stored content database 50, a content cache 60, one or more dynamic data sources 70 and one or more application program interfaces 85 that reside on a distribution channel server 80. The function of and interaction between each of these components are described in the following paragraphs.

Broadcast operation centers like that referenced as BOC 15 in FIG. 1 are well known in the art. In general, the BOC 15 uses known systems and methods to schedule and transmit the broadcast signal to a television network. The television programs that are aired by the BOC 15 are typically stored on audio-video media, such as videotape, and are scheduled via a broadcast automation system. In a preferred embodiment, the BOC 15 uses the Chyron/Pro-Bel sextant automation suite to control the broadcast feed because this particular automation suite generates a playlist 20 that can be readily accessed via a serial feed from the Pro-Bel rack mount. But one of ordinary skill in the art will recognize that any broadcast system or automation suite can be used with the present invention so long as a schedule of programs is generated and can be accessed by the enhanced media generation and distribution system 10.

The playlist 20 is essentially a data file with information about the program segments that are scheduled for broadcast from the BOC 15. In a preferred embodiment, the playlist 20 includes fields for event number, start time, title, duration, event identifier and type. The event number is used to identify in which order the program segments will be aired. The program segment that corresponds to event number zero is the program that is currently on-air; the program segment that will air next is event number one and so on. When the current on-air program segment completes and the next program segment begins, the new on-air program segment becomes the new event number zero and the other program segments listed move up the playlist 20. In a preferred embodiment, the playlist 20 is a window that shows the next ten program segments to be aired (event numbers zero to nine). As an on-air program completes, the program moves off of the playlist 20 and a new program segment is added to the bottom of the playlist 20 as event number nine.

The start time is the next field in the playlist 20 and represents the time at which the event is scheduled to begin. The title field includes a description of the event. In a preferred embodiment, an event represents any segment of a television program, commercial or network identifier. Thus, for example, a thirty-minute sitcom might have one event that represents the first fifteen minutes of the sitcom, three or four events that represent commercials, an event for a network logo, and finally another event that represents the final fifteen minutes of the sitcom. One of ordinary skill in the art will readily recognize that the manner in which a program segment is separated into events is not critical to the invention. Thus, for example, in one embodiment each commercial represents a single event, while in an alternative embodiment, all commercials that run between two segments of a thirty-minute sitcom may be assigned to a single event in the playlist 20.

The duration field of the playlist 20 represents the length of the event. When the event becomes event number zero, that is, when the event is on-air, the duration field becomes a countdown of the time remaining in the event. The event identifier is a unique identifier that identifies the event. As discussed below, the enhanced media generation and distribution system 10 to associate which, if any, media elements to display during the event to enhance the broadcast program use the event identifier. The type field references an event type and, in a preferred embodiment, has values for event types such as break header (B), commercial (C), junction (J), live (L) and program (P).

Another field that optionally may be included in the playlist 20 is an automation status field or automation status message. In one embodiment, the automation status message indicates whether the events that are actually be broadcast coincide with the playlist data. Thus, for example, if an event runs past its scheduled end time, an operator may intervene and put the broadcast automation on-hold pending an adjustment of the event schedule or until the on-air event completes. As another example, the automation status message can indicate that the automation mode is turned off. This could mean that the events that are being broadcast do not necessarily correspond to the events shown in the playlist 20. One of ordinary skill in the art will recognize that the system and methods described below can include a step of checking the automation status message to confirm that the events shown in the playlist 20 are actually being broadcast before the media presentation intended to enhance the programming is assembled and/or delivered.

Returning again to the block diagram of FIG. 1, the relayer 30 represents an application that captures the playlist 20 from the BOC 15 and converts the playlist 20 into a format that can be used by the enhanced media generation and distribution system 10. In a preferred embodiment, the relayer 30 broadcasts the playlist 20 over a local area network (LAN) via a TCP/IP protocol. Although FIG. 1 only shows the relayer 30 sending the playlist 20 to the broadcast timing server 35, one of ordinary skill in the art will recognize that other applications may communicate with the relayer 30 via the LAN to obtain the information contained in the playlist 20.

The broadcast timing server 35 receives the playlist feed from the relayer 20 and parses the data to capture the list of events that are scheduled for broadcast. In a preferred embodiment, the playlist data is updated and passed to the broadcast timing server 35 twice per second. In one embodiment, the current event is updated once per second and an event entry between one and nine is updated once per second approximately half a second after the current event is updated. A function of the broadcast timing server 35 is to parse the playlist and determine whether a triggering event has occurred. A first triggering event identified by the broadcast timing server 35 is referred to herein as an on-air trigger and represents a change in the on-air event. In operation, the broadcast timing server 35 parses the playlist and examines the current on-air event. If the on-air event is a new event then the broadcast timing server 35 sends an on-air trigger to the timing applications 45 on the content timing server 40, notifying them that a new event has moved to event number zero. But if the broadcast timing server 35 determines that the on-air event is a continuation of a current event, the on-air trigger is not sent.

Another triggering event identified by the broadcast timing server 35 is referred to herein as an on-horizon trigger and indicates that a new event has moved onto the playlist 20. In general, when a new event appears on the playlist 20 it will appear as event number nine and the event will be concurrent with a new event moving to the on-air slot. But in a preferred embodiment, the broadcast timing server 35 compares every event number in the playlist 20 against the most recent playlist data to determine whether a new event has appeared. The reason for this is that certain events, such as live sporting events, can run past their scheduled end-times and force unanticipated changes to the playlist 20. In some cases, events that were scheduled to broadcast may be skipped, or the playlist 20 may be adjusted to adapt to the new broadcast schedule. In a preferred embodiment, the broadcast timing server 35 is configured to recognize any change to any event in the playlist 20 and will notify the timing applications 45 of the change.

The next component of the enhanced media generation and distribution system 10 is the timing applications 45. The operation of the timing applications 45 are described in greater detail below, but in general the timing applications 45 act as media presentation engines that are responsible for identifying an retrieving the media elements that are used to enhance the broadcast of the event. The timing applications 45 handle the assembly of the various media elements into a media presentation and the synchronous delivery of the assembled media presentation to the distribution channels.

In a preferred embodiment, the timing applications 45 are client-specific, that is, a dedicated timing application 45 is established for each distribution channel. Thus, in the system shown in FIG. 1, Wink Communications, a well-known provider of interactive services via broadcast and cable systems, has its own dedicated timing application 45. Similarly, separate timing applications 45 are shown in the figure for distribution channels for personal video recorders (PVR) and wireless and satellite platforms. This list is not intended to be exhaustive and one of ordinary skill will recognize that these are but a few of the many known distribution channels through which audiovisual media and interactive content can be delivered to users in accordance with the present invention.

An advantage to having a timing application 45 dedicated to each client's distribution channel is that the timing application 45 can be configured to handle the specific business rules for the client and the specific hardware limitations or requirements of the distribution channel. Thus, if a particular client has a rule that prohibits the execution of the enhanced media presentation during commercial breaks, the timing application 45 for that client can be programmed to implement that specific business rule. Similarly, a timing application 45 that is dedicated to a particular distribution channel can be readily programmed to assemble and deliver an enhanced media presentation that is tailored to the hardware requirements and limitations of that distribution channel.

For the sake of clarity and ease of explanation, the timing applications 45 described herein will be described as client-specific applications 45 that are dedicated to a single distribution channel. But one of ordinary skill in the art will understand that a single timing application 45 can be readily configured to serve multiple clients and multiple distribution channels. In such an embodiment, the client-specific business rules and distribution requirements can be stored in a client database and accessed on an as-needed basis. Similarly, one of ordinary skill will recognize that the content timing server 40 might alternatively contain a mix of general and client-specific timing applications 40. In this alternative embodiment, some of the processes that are attributed herein to the client-specific timing applications 45 are, in fact, performed by a general timing application 45 and the results passed to the client-specific timing applications 45. Thus, for example, a general timing application 45 may handle the retrieval of a media element from a remote location and store a copy of the media element in local memory that can be accessed by the client-specific applications 45. These are but a few of the alternative designs of the system that is encompassed by the present invention and many more will be readily apparent to one of ordinary skill in the art.

With reference again to FIG. 1, the next system component shown in FIG. 1 is the content database 50. The content database 50 is a storage space for much of the media elements that are used to enhance the broadcast signal and also for many of the data structures (described below) that describe how the media elements are used to enhance the broadcast signal. In a preferred embodiment, the content database 50 stores the media elements that are static or, at a minimum, stores a reference address such as a Uniform Resource Locator (URL) that tells the timing applications 45 where the media elements are located. Similarly, although dynamic media elements are not physically stored in the content database 50, the database will include a content identifier that identifies the dynamic data source from which the dynamic media elements can be retrieved.

Static media elements as that term is used herein refers to those media elements that are not affected by the time delay between the point at which the media element is retrieved and the point at which it is delivered to the distribution channels. Dynamic media elements, on the other hand, represent those media elements that are more time sensitive and are typically retrieved at or near runtime. An example of a static media element is a biography of an actor that is appearing on a television program. Although the details of the actor's life may change over time, the biography is considered a static media element because the data in the biography is not affected by the short delay between the time when the biography is retrieved and the time that it is broadcast. In contrast, a presentation of live sports scores and statistics from an Internet sports service would be an example of a dynamic media element where the relevance and accuracy of the data is time-sensitive.

The following paragraphs describe the operation of the enhanced media generation and distribution system 10 in accordance with a preferred embodiment of the present invention.

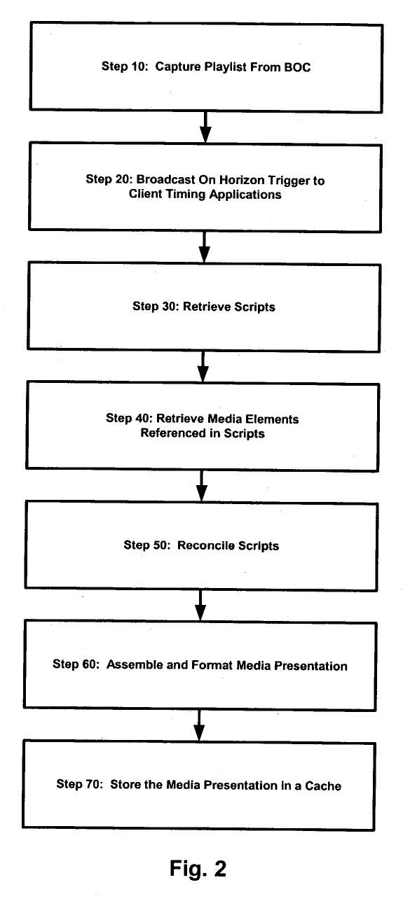

FIG. 2 is a flow chart that illustrates the process flow that occurs when a new event appears on the playlist 20. In Step 10, the broadcast timing server 35 receives the playlist 20 from the BOC 15 via the relayer 30. In Step 20, the broadcast timing server 35 parses the playlist data feed, compares the new playlist data against the most recent playlist and finds that a new event has entered the playlist 20. In response, the broadcast timing server 35 sends an on-horizon trigger to the timing applications 45 notifying them of the presence of a new event. In a preferred embodiment, the broadcast timing server 35 uses the on-horizon trigger to pass information to the timing applications 45 about the new event including, the event number, start time, title, duration, event identifier and event type.

In a preferred embodiment, the on-horizon trigger is broadcast to all of the client-specific timing servers 45. The following paragraphs describe the processing of the on-horizon trigger by a single timing application 45 but it should be understood that each of the timing applications 45 are simultaneously performing the same steps using the client-specific business rules and content enhancement criteria established for each timing application 45.

In Step 30, a timing application 45 receives the on-horizon trigger from the broadcast timing server 35 and queries the content database 50 with the event identifier to capture one or more scripts that are associated with the new event. The term script is used herein to reference computer code that delineates how media elements are to be used to enhance the event associated with that event identifier. In a preferred embodiment, many different types of scripts can relate to a single event identifier and each script is assigned a priority in a script hierarchy that determines which script is actually used when the event is broadcast. Examples of the different type of scripts include a network script, a franchise script, a title script, a version script, an airing script and a timetable script.

The network script is typically the lowest script in the hierarchy and is used when an on-horizon trigger is received that either has no event identifier or has an event identifier that is associated with no other scripts. A network script might, as one example, instruct the timing application 45 to enhance the broadcast signal with a network program schedule for that day or a list of the programs scheduled to follow the current program.

The next script in the script hierarchy is the franchise script and is used when the new event is associated with a specified franchise. Examples of a franchise might include a television sitcom such as “Friends” or a network presentation that repeats on a regular basis like the “Dinner & a Movie” franchise. Unlike the network script, the franchise script applies to a particular series and thus might include enhanced content in the form of biographical information and pictures about regular cast members, a trivia game with questions about past episodes, or even a streaming video of a clip from a recent movie in which one or more of the cast members had a starring role.

The title script is the next script in the script hierarchy and is used when the new event is associated with a particular television program. Whereas the franchise script might apply to a particular franchise series, like “Friends,” the title script would apply to a particular episode of the “Friends” franchise. Thus, in addition to the enhancement content that refers to the entire franchise, the title script may also direct the timing application 45 to enhance the broadcast signal with information about the particular episode that is being broadcast. As an example, the title script may use pictures and biographical information about a guest star that appears on a particular episode.

The version script is the next script in the hierarchy and is even more show-specific than the title script in that only applies to a specific edit of a specific show. In the television industry, multiple edits of a single show are common if, for example, the show contains objectionable content. Because different networks may have different thresholds of what is considered acceptable content, each network may broadcast a different edit of the same show. Or a network might broadcast a special edit of a show that shortens the runtime of the show and allows the network to show additional commercial spots. A version script is tied to a specific edit of a show and might, for example, instruct the timing application 45 to broadcast a shortened version of a trivia game that was created for a longer edit of a particular show. A benefit of having a script type that is specific to a distribution channel is that media elements can be assembled for particular distribution channels in accordance with specific business rules or hardware requirements associated with a channel.

The airing script is the final show-specific script and is also generally the highest script in the script hierarchy. Like the version script, the airing script is associated with a specific edit of a show but the airing script is even more specific in that it relates to a particular time slot in which that edit will air. Thus, for example, an airing script may be created for a particular edit of a particular episode of the “Friends” franchise that will air at 11:30 P.M. on Dec. 31, 2003. In this example, the airing script might instruct the timing application 45 to enhance the broadcast signal with a clock at the bottom of the screen that counts down to the New Year.

Another type of script that can be used with the present invention is the timetable script. Unlike the previously discussed scripts, the timetable script is not tied to a particular program but to a particular time slot. While the timetable script generally has a lower priority in the script hierarchy than all but the network script, its priority can be adjusted so that the timetable script overrides some or all of the other scripts. Such an adjustment might be used, for example, if a particular media presentation had to be broadcast at a particular time without regard to the specific television program that is airing at the time.

Timetable scripts also have value in connection with the broadcast of live sporting events. For example, a network may broadcast professional football games every Sunday afternoon between 3:00 P.M. and 6:00 P.M. A timetable script can be created that instructs the timing application 45 to enhance the broadcast signal during that three-hour time slot with a continuous feed of sports scores and statistics.

Another potential use of the timetable script is to replace the network script as the default script. Timetable scripts thus could be created for any time slot in the network schedule and the timing application 45 configured to default to these timetable scripts if an event is received that either does not have an event identifier or has an event identifier that is not associated with a show script. These examples are intended to be illustrative and many more uses for the timetable and other aforementioned scripts will be readily apparent to one of ordinary skill in the art.

Returning again to FIG. 2, in Step 40 the timing application 45 retrieves the media elements that are referenced in each of the scripts. Multiple scripts are often associated with a single event identifier and in this step the timing application 45 parses every applicable script and retrieves the media elements referenced in each. The process used to retrieve and assemble the media presentation delineated in the scripts is discussed below, but, in general, in Step 40 the various media elements that make up each script are retrieved and stored in a temporary memory area.

In Step 50, the timing application 45 reconciles the scripts that are associated with the event to determine which of the scripts will be followed in generating a media presentation that will be synchronized to the broadcast signal. Typically, the timing application 45 will use the default script priority to reconcile the scripts. Thus, if a network script, franchise script and version script are all associated with a given event, the timing application 45 would follow the version script as it has a higher script priority than the network and franchise scripts. But as discussed above the priority of the scripts can be modified so that the default script hierarchy can be overridden as needed.

In Step 60, the timing application 45 retrieves the media elements that are referenced in the script that was selected in the reconciliation process and assembles the data into a media presentation. The processes used to assemble the media elements into a media presentation are well known in the art. And one of ordinary skill will recognize that the specific processes required to format any media element depends on the type of media that will be used and the client on which it will be displayed. For example, if a timing application 45 is enhancing a broadcast signal with text, the timing application 45 must paginate the text so that the proper amount of text appears on each page. And the determination of how much text will fit on each page is determined by the client that is to broadcast the text. Similarly, if the media elements take the form of a graphic image the dimensions of the image to be displayed on the television screen depend on the client that is to broadcast the image. As previously noted, the timing applications 45 are client-specific and therefore are preferably pre-configured to assemble and format the media elements in any manner required by their respective clients.

In Step 70, the timing application 45 stores the assembled media presentation in the content cache 60. In a preferred embodiment, the media elements that comprise the media presentation are physically formatted and stored in the content cache 60 in the format that will be used to broadcast them. Thus, for example, if a media presentation consisted entirely of text enhancements, each page of the paginated text presentation is physically stored in the cache 60. In an alternative embodiment, some or all of the media elements that comprise the assembled media presentation are not physically stored in the cache 60 and instead the cache 60 contains an address or other index to identify the location of the media element. Thus, for example, instead of storing an image file on the cache 60, the cache 60 may instead hold a URL address that points to the actual image file.

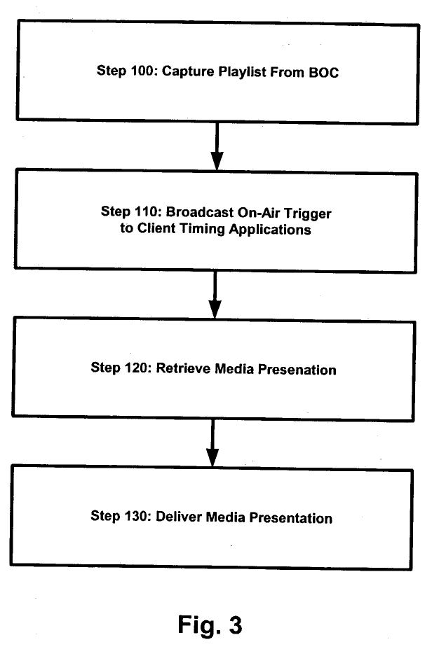

At the completion of the process shown in FIG. 2, a media presentation that will be used to enhance the broadcast of an event is assembled and stored in a content cache 60. In a preferred embodiment, the media presentation remain in the cache 60 until the timing application 45 receives notice that the event is at event position zero and has started to broadcast. FIG. 3 is a flow chart that shows the process flow that occurs when the event goes on-air.

In Step 100, the broadcast timing server 35 receives the playlist 20 from the BOC 15 via the relayer 30. In Step 110, the broadcast timing server 35 parses the playlist data feed, compares the new playlist data against the most recent playlist and determines that a new event is on-air. The broadcast timing server 35 then notifies the timing applications 45 via an on-air trigger of the new on-air event. In a preferred embodiment, the on-air trigger includes the data from the playlist 20 about the new on-air event, including data fields for event number, start time, duration, event identifier and event type.

In Step 120, the timing application 45 captures the event identifier from the on-air trigger and retrieves the media presentation from the content cache 60 that is associated with that on-air event. As part of this process, the timing application 45 will retrieve any dynamic media elements that are referenced in the script for this event.

In a preferred embodiment, when dynamic content is referenced in a script for an event the script content identifier for the dynamic content will include a URL or other link to the dynamic data source 70 from which the dynamic media elements are to be retrieved. The most common format used to retrieve dynamic media is an XML feed. But one of ordinary skill in the art will readily recognize that other methods of capturing dynamic media are known in the art and can be used with the present invention.

When the timing application 45 receives the on-air trigger, the timing application links to the dynamic data source 70 and captures the XML feed. Typically, the XML feed contains data that may not be required by the timing application 45 and the timing application 45 must parse the XML feed to obtain the data that is part of the script. As with the static media elements, the dynamic media elements must also be assembled and formatted so that they will be displayed in the proper format. To do this, the timing application 45 uses the data from the original XML feed to create a second XML feed that includes only that information referenced in the script. Moreover, the second XML feed preferably includes media display instructions or attributes that are well known in the art that will instruct the client how the dynamic media elements should be displayed. This data is then transferred to the cache where it becomes part of the media presentation that will be merged with the broadcast signal.

In Step 130, the timing application 45 delivers the assembled media presentation to the application program interface 85 of the distribution channels, where the media presentation is merged with the broadcast signal. The systems and processes required to merge the media presentation to the broadcast signal are well known in the art and are outside the scope of this description of the invention. One of ordinary skill in the art will readily recognize that the systems and processes required to associate the media presentation to a broadcast signal or to another media format depend on the type of distribution channel used to transmit the event to the viewer and the platform used to deliver the media. Some of the well-known processes that are used to enhance a broadcast signal include, without limitation, multiplexing the media presentation with a broadcast signal and insertion of the media presentation into a vertical blanking interval of the broadcast signal.

The fact that the media presentation is assembled independently of the distribution channel that is used to broadcast the enhanced broadcast signal is a novel aspect and an advantage of the present invention. The foregoing paragraphs describe a system that monitors a broadcast schedule and notifies a plurality of client-specific timing applications 45 whenever a new event enters the playlist 20. While each timing application 45 receives the same event identifier, the scripts and media elements that the timing application 45 retrieves and assembles in response to that event may be entirely different. In a preferred embodiment, each timing application 45 is configured to collect and assemble a media presentation for a client, and because each client has its own unique set of business rules and hardware limitations, the media presentation assembled by a first timing application 45 may be entirely different from the media presentation assembled by a second timing application 45.

As an example, in response to a particular event identifier, a first timing application 45 uses a script that instructs the application to assemble a media presentation in the form of text overlay that provides the viewer with a series of tabs that offers a program description, a biography of each cast member in the program and a list of times during the next week when that program is scheduled to air. A second timing application 45 receives the same event identifier but the client associated with the second timing application has configured it to generate a media presentation in the form of a multi-player trivia game for that event. And a third client-specific timing application 45 can be configured to deliver an advertisement to its viewers in the form of a streaming video, still in response to the very same event identifier.

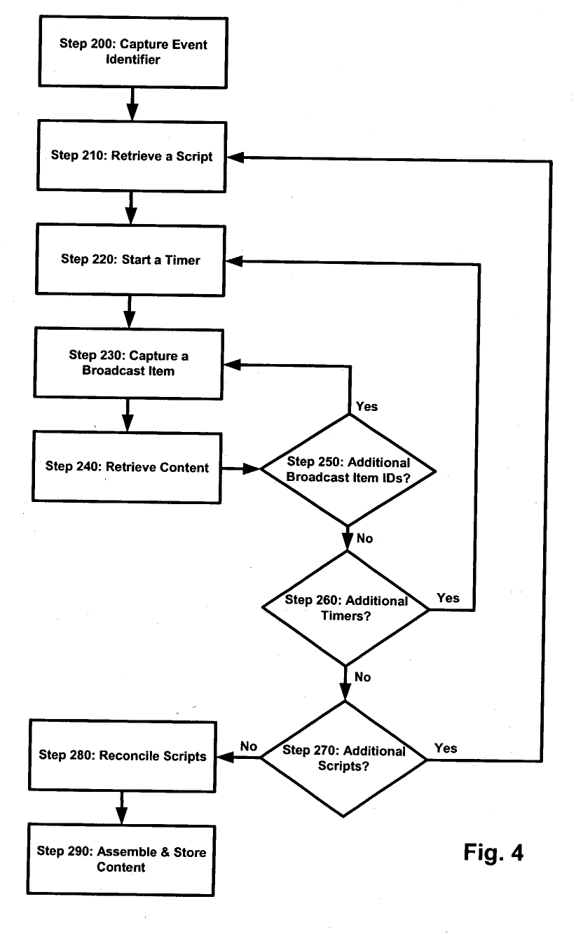

FIG. 4 shows a flow chart that illustrates the steps used to retrieve and assemble the various media elements that comprise the media presentation. In Step 200, the timing application 45 receives an on-horizon trigger as a new event enters the broadcast playlist 20. In a preferred embodiment, the on-horizon trigger typically includes an event identifier for the event, which the timing application 45 uses in Step 210 to query the content database 50 to retrieve the scripts associated with the event. In the event that either the on-horizon trigger does not include an event identifier, or that the query with the event identifier does not find an associated script, the timing application 45 will default to a script such as a network or timetable script. In many cases, however, the timing application 45 can find several scripts that are associated with the event.

In a preferred embodiment, every script that is retrieved from the content database 50 has its own unique script identifier, and in Step 220, the timing application 45 uses that script identifier to query another table in the content database 50 to obtain a first timer for the first script. As described below, the timing application 45 associates timers with the media elements and uses the timers to synchronize the launch of the media presentation with the broadcast signal. For example, a particular event may have a duration of ten minutes and the script for that event may require that a first media presentation be used for the first half of the event and that at seven minutes and thirty seconds into the event that the timing application launch a second media presentation. In this example, a first timer would be generated for the script to launch the first media presentation as soon as the event goes on-air. A second timer would also be started at the moment the event goes on-air, but rather than immediately launching the second media presentation the second timer would countdown from seven minutes and thirty seconds into the event before triggering the timing application 45 to launch the second media presentation.

In a preferred embodiment, timers also play a role in the delivery of dynamic content. For example, a script for a live broadcast of a sporting event can direct the timing application 45 to capture live scores and statistics about the sporting event from a dynamic content source 70 and to display those scores and statistics in a banner across the bottom of the television screen. In such case, a timer can be created so that at predetermined intervals, every fifteen seconds for example, the timer sends a trigger to the timing application 45 requesting an update of the dynamic content, which, in this example, causes the timing application 45 to retrieve the latest scores and statistics from the dynamic data source 70. Once the updates data is retrieved, the timing application 45 transfers the data to the content cache 60 and immediately launches the data from the cache 60 to the distribution channels.

Returning to FIG. 4, in Step 230 the timing application 45 uses a timer identifier that uniquely identifies the timer to query a broadcast items table, which preferably resides in the content database 50. At least one broadcast item is associated with each timer identifier and there may be more than one broadcast item for every timer. In a preferred embodiment, the broadcast item table includes a broadcast item identifier that uniquely identifies the record and further includes a content identifier that identifies the media elements (i.e. raw content) that will be synced with the broadcast signal to enhance the video program. In Step 240, the timing application 45 uses the content identifier to retrieve the media elements identified in the broadcast item record.

To list every possible content format that might be used to enhance a television program is almost impossible and regardless is outside the scope of this invention description. One of ordinary skill in the art is familiar with the wide variety of formats that enhancement content can take, including, without limitation, text, graphic or photographic images, streaming video, links to Internet sites or to any one of a variety of dynamic data sources.

In a preferred embodiment, the content identifier in a broadcast item record can link to any and every form of media that may be used to enhance a video program. Moreover, the content identifier may refer to media content that, in turn, references multiple other media elements. As an example, the content identifier in a broadcast item record may link to a list content. And the list content may itself point to multiple other media elements that can each be accessed randomly, in carousel format or in a concatenated form. In the case of a media element that takes the form of a content list, the broadcast item record that references the content list will identify some or all of the media elements referenced by the content list (the broadcast item may request access to a single media element from a content list, a subset of the media elements from the list or the entire list) and the manner in which they should be accessed (i.e. random, sequential or concatenated).

A content identifier in a broadcast item list thus can refer to a specific media element or to a data structure that references multiple media elements. In the case of the content list, a broadcast item has the flexibility to identify a content list and decide that the first time the content list is accessed a first media element should be used and the next time the content list is accessed a second media element should be used and so on. This use of varying levels of content data structures offers enormous flexibility in the way that the media elements can be combined and scripted for an event.

Returning again to FIG. 4, when the timing application 45 has retrieved all of the media elements referenced in the first broadcast item the process proceeds to Step 250 to see if additional broadcast items are referenced in the timer. If there are additional broadcast items, the process returns to Step 230 where the next broadcast item is retrieved and the process of retrieving media elements is repeated. When the content for all of the broadcast items in the timer has been retrieved, the process proceeds to Step 260 to see if additional timers are referenced in the script. If there are additional timers, the process returns to Step 220 and the process repeats for the new time. When the media elements for all of the broadcast items in all of the timers has been retrieved, the process proceeds to Step 270 to see if additional scripts match the event identifier for the new event. If there are additional scripts, the timing application 45 returns to Step 210 and the process repeats until the content referenced in every script is retrieved.

In Step 280, the timing application 45 examines the priority of each of the scripts to determine which will be used when the event is broadcast. A default priority is associated with every script and the script with the highest priority is generally the script that is selected. But in a preferred embodiment, the default priorities of the script can be modified or overridden thereby providing a user with the ability to specify that a particular script run with a certain event or during a particular time slot.

In Step 290, the media elements referenced in the script that was selected by the reconciliation process are assembled and formatted according to the particular requirements of the media and the client that will receive the assembled media presentation. Once the media presentation is assembled, the timing application 45 transfers the formatted content to the content cache 290 where it is stored until the event goes on-air.

One of ordinary skill will recognize that a benefit to the present invention is that it addresses the problem of synchronizing the media presentation to the broadcast feed. At present, enhancement content is synced to the broadcast signal either through a manual process that cannot respond to an unanticipated change in the broadcast schedule, or via one of several processes that physically links the enhancement content to the broadcast signal. In contrast, the present invention uses the on-horizon trigger from the broadcast timing server 35 to alert the timing applications 45 when a new event enters the broadcast playlist 20. This alert gives the timing applications 45 sufficient advance notice of the event that the timing applications 45 have an opportunity to retrieve, assemble and cache the content in advance of the event going on-air. Thus, when the broadcast timing server 35 sends the on-air trigger, some or all of the content is already assembled and ready for transfer to the distribution channel so that it will sync with the broadcast signal. And, because the broadcast timing server continuously monitors the broadcast playlist 20, the enhanced media generation and distribution system 10 can respond to any unanticipated scheduling changes that may occur.

In concluding the detailed description, it should be noted that it will be clear to those skilled in the art that many variations and modifications can be made to the preferred embodiment without substantially departing from the principles of the present invention. Also, such variations and modifications are intended to be included herein within the scope of the present invention as set forth in the appended claims. Further, in the claims hereafter, the structures, materials, acts and equivalents of all means or step-plus function elements are intended to include any structure, materials or acts for performing their cited functions.

That which is claimed:

1. An interactive information system that assembles and delivers a media presentation that is used to enhance a video event, said media presentation delivered to a distribution channel at a time that coincides with a broadcast of said video event, the system comprising:
a broadcast timing server that monitors a playlist of events that are scheduled for broadcast and is configured to generate an on-horizon and an on-air trigger, wherein said on-horizon trigger indicates that a new video event has entered said playlist and said on-air trigger indicates that said new video event has started to broadcast; and
a media presentation engine that assembles said media presentation in response to said on-horizon trigger and delivers said media presentation to said distribution channel in response to said on-air trigger.

2. The system of claim 1, wherein said on-horizon trigger includes an event identifier that identifies said new video event.

3. The system of claim 2, wherein said media presentation engine is configured to query a media content database with said event identifier to retrieve a script that identifies said media presentation that is associated with said new video event.

4. The system of claim 3, wherein said script identifies one or more media elements that are associated with said video event and said media presentation engine is configured to assemble said media presentation from said one or more media elements.

5. The system of claim 4, wherein said media presentation engine is further configured to associate at least one timer with said one or more media elements and to start said at least one timer in response to said on-air trigger.

6. The system of claim 5, wherein said media presentation engine is further configured to deliver at least some of said one or more media elements at a time determined by said timer.

7. The system of claim 5, wherein said media presentation engine is further configured to retrieve a media element from a dynamic data source at a time determined by said timer.

8. The system of claim 1, further comprising a media content cache that receives said media presentation from said media presentation engine and stores said media presentation until said new event has started to broadcast.

9. The system of claim 8, wherein said media presentation engine is configured to store said media presentation in said media content cache once said media presentation is assembled, and to transfer said media presentation to said distribution channel when said on-air trigger is received.

10. The system of claim 1, wherein said broadcast timing server monitors said playlist by retrieving a new playlist once every second.

11. The system of claim 6, wherein said broadcast timing server identifies a change in said playlist by comparing said new playlist against a previous playlist.

12. The system of claim 1, wherein said playlist is generated by a broadcast operations center.

13. A method of assembling and delivering a plurality of media presentations to a plurality of distribution channels, said deliveries coinciding with a broadcast of an event, said method comprising the steps of:
receiving a first notice that indicates that said event has entered a playlist of events that are scheduled for broadcast;
assembling a first and second media presentation in response to said notice; and
delivering said first media presentation to said first distribution channel and said second media presentation to said second distribution channel upon receipt of a second notice that indicates that said broadcast of said event has started.

14. The method of claim 13, wherein said delivering of said first and second media presentation occurs simultaneously.

15. The method of claim 13, wherein said first distribution channel is associated with a first platform used to deliver said broadcast signal and said second distribution channel is associated with a second platform used to deliver said broadcast signal.

16. The method of claim 13, wherein the step of delivering said first and second media presentations comprises the steps of delivering said first media presentation to a first application program interface that is associated with said first distribution channel and delivering said second media presentation to said second program interface that is associated with said second distribution channel.

17. The method of claim 16, further comprising the step of combining said first media presentation with said broadcast of said event to create a first enhanced broadcast signal, and combining said second media presentation with said broadcast to create a second enhanced broadcast signal.

18. The method of claim 17, wherein said first enhanced broadcast signal is broadcast via a first video transmission platform and said second enhanced broadcast signal is transmitted via a second video transmission platform.

19. The method of claim 17, wherein said first enhanced broadcast signal is a result of inserting said first media presentation into a vertical blanking interval of said event broadcast.

20. The method of claim 17, wherein said first enhanced broadcast signal is a result of multiplexing said first media presentation with said event broadcast.

21. A method of assembling and delivering a media presentation to a distribution channel to coincide with the broadcast of an event, said method comprising the steps of:
receiving an on-horizon trigger that indicates said event is scheduled for broadcast, said on-horizon trigger including an event identifier that is associated with said event;
querying a database of media elements with said event identifier to capture a script that is associated with said event, wherein said script identifies one or more media elements that are to be broadcast with said event;
assembling a media presentation based at least in part on said one or more identified media elements; and
delivering said assembled media presentation to said distribution channel upon receipt of a notice indicating that a broadcast of said event has started.

22. The method of claim 21, wherein the step of assembling said media presentation comprises:
retrieving said one or more media elements from a media content database;
formatting said one or more media elements for said distribution channel; and
storing said media elements in a cache.

23. The method of claim 22, wherein the step of delivering said assembled media presentation comprises transferring said formatted media elements from said cache to said distribution channel.

24. The method of claim 21, wherein the step of delivering said assembled media presentation comprises the steps of:
receiving a notice that indicates that a broadcast of said event has started;
parsing said notice to capture an on-air event identifier for said event;
querying said cache with said on-air event identifier to identify said media presentation that is associated with said event; and
transferring said media presentation from said cache to said distribution channel.

25. The method of claim 21, wherein the step of delivering said assembled media presentation comprises the steps of:
receiving a notice that indicates that a broadcast of said event has started;
parsing said notice to capture an on-air event identifier for said event;
querying said cache with said on-air event identifier to identify said media presentation that is associated with said event;
capturing one or more dynamic media elements from at least one dynamic data source;
merging said dynamic media elements with said cached media elements; and
transferring said media presentation from said cache to said distribution channel.

26. A method of using media to enhance a video event and of delivering said enhancements to a distribution channel to coincide with the broadcast of said video event, said method comprising the steps of:
receiving a notice that indicates that said video event has entered a playlist of events that are scheduled for broadcast;
retrieving a plurality of scripts that are associated with said video event;
selecting one of said plurality of scripts to use with said broadcast of said video event;
assembling a media presentation associated with said selected script; and
delivering said media presentation to said distribution channel to coincide with said broadcast of said video event.

27. The method of claim 26, wherein each of said plurality of scripts identifies a different media presentation.

28. The method of claim 27, wherein said playlist comprises a list of the next ten events that are scheduled for broadcast.

29. The method of claim 28, wherein each of said next ten events are assigned an event position in said playlist, wherein further said event position zero represents an event that is currently being broadcast and event position nine represents the last one of said next ten events to be broadcast.

30. The method of claim 29, wherein said notice is received when said video event enters said playlist at said event position nine.

31. The method of claim 30, wherein the step of selecting one of said plurality of scripts comprises selecting the script that has the highest priority in a script hierarchy.

32. A method of synchronizing a media presentation for an event that is scheduled to air on a television network and of delivering said media presentation to said network via a distribution channel that is associated with said television network, said method comprising the steps of:
capturing an event identifier for said event;
querying a database of media elements to identify one or more media elements that are associated with said event identifier;
assembling said media presentation based at least in part on said identified media elements;
caching said media presentation; and
delivering said media presentation to said distribution channel in response to a notice that said event has started to broadcast.

33. A method of enhancing a video event by delivering a media presentation to a distribution channel to coincide with the start of a broadcast of said video event, said method comprising the steps of:
receiving a notice that indicates that said video event has entered a playlist of video events that are scheduled for broadcast;
retrieving a script that is associated with said video event, wherein said script describes a media presentation that is associated with said video event and said media presentation includes a static portion and a dynamic portion;
assembling said static portion of said media presentation;
storing said static portion in a memory area;
retrieving said dynamic portion of said media presentation in response to a notice that said broadcast of said video event has started; and
delivering said static and dynamic portions of said media presentation to said distribution channel.

34. The method of claim 33, wherein the step of retrieving a dynamic portion of said media presentation comprises retrieving one or more media elements from a dynamic data source.

35. The method of claim 33, wherein the step of retrieving a dynamic portion of said media presentation comprises retrieving an XML feed from a dynamic data source.

36. The method of claim 35, further comprising the step of parsing the XML feed to capture one or more media elements that are referenced in said script.

37. The method of claim 36, further comprising the step of generating an internal XML file that comprises said one or more media elements referenced in said script and at least one media display instruction that describes how said one or more media elements are to be displayed.

38. An interactive information system that assembles and delivers a media presentation that is used to enhance a video event, said media presentation delivered to a distribution channel at a time that coincides with a broadcast of said video event, the system comprising:
a broadcast timing server that monitors a playlist of events that are scheduled for broadcast and generates a trigger when a new video event enters said playlist, wherein said trigger includes an event identifier that is associated with said new video event; and
a media presentation engine that receives said trigger and queries a media database with said event identifier to identify a plurality of media presentations that are associated with said new video event, said media presentation engine further configured to select one of said plurality of media presentations and to assemble and deliver said selected media presentation to said distribution channel when said new video event begins to air.

39. A method comprising:
detecting entry of a media event into a playlist;
assembling a media presentation based on said media event, said media presentation for enhancing said media event; and
delivering said media presentation for broadcast along with said event based on said event reaching the top of said playlist and beginning to play.

40. A method as claimed in claim 39, wherein said media event is a video segment.

41. A method as claimed in claim 39, wherein said media event is an audio segment.

42. A method as claimed in claim 39, wherein said media presentation is assembled by execution of a script retrieved from a database using an event identifier associated with said media event.

43. A method as claimed in claim 40, wherein said script is associated with a particular distribution channel to which said media presentation and said media event are delivered.

44. A method as claimed in claim 40, wherein said script is associated with a particular customer to which said media presentation and said media event are to be delivered.

45. A method comprising:
retrieving a script based on a media event to be broadcast;
executing said script to generate a media presentation to be broadcast with said media event; and
delivering said media presentation for broadcast along with said media event.

46. A method as claimed in claim 45, wherein said script includes a business rule associated with a customer for whom said media presentation and said media event are delivered.

47. A method as claimed in claim 45, wherein said script includes a business rule associated with a distribution channel to which said media presentation and said media event are delivered.
